(19) United States
(12) Patent Application Publication
(10) Pub. No.: US 2014/0037799 A1
(43) Pub. Date: Feb. 6, 2014

(54) OAT CEREAL CONTAINING AGGLOMERATED FLAVOR CLUSTERS

(71) Applicant: MOM Brands Company, Minneapolis, MN (US)

(72) Inventors: David Klaus Duffy, Maple Grove, MN (US); Matthew John Engel, Lakeville, MN (US)

(73) Assignee: MOM BRANDS COMPANY, Minneapolis, MN (US)

(21) Appl. No.: 13/791,112

(22) Filed: Mar. 8, 2013

Related U.S. Application Data
(60) Provisional application No. 61/679,459, filed on Aug. 3, 2012.

(51) Int. Cl. A23L 1/168

(52) U.S. Cl. CPC A23L 1/168
USPC 426/93; 426/619; 426/285

(57) ABSTRACT

Agglomerated flavor clusters comprising a binder syrup, grain, sweetener, and flavoring agent, and hot cereal compositions comprising the agglomerated clusters are described. The agglomerated flavor clusters are hydroscopic and can be directly consumed similar to granola or mixed into a bulk hot cereal composition. When heated, the agglomerated flavor clusters liquefy and coat the grain components of the hot cereal composition providing a flavored hot cereal composition. As the agglomerated clusters exhibit reduced settling in hot cereal compositions, each single serving of the bulk hot cereal compositions of the disclosure comprises substantially the same flavor intensity and nutritional value.

This application claims priority to U.S. application Ser. No. 61/679,459 filed Aug. 3, 2012, which is hereby incorporated by reference in its entirety.

### BACKGROUND

Flavored bulk hot cereal products, such as bulk canned oats, that satisfy consumer perceptions and expectations for a flavored hot cereal, such as a flavored oat meal, have previously been impractical due to the fact that flavoring agents, sweeteners, and inclusions have bulk densities that are different from the grain component of the hot cereal. This differential in bulk densities generally results in the settling of the flavoring agents, sweeteners, and/or inclusions to the bottom of the bulk package over time, which has a detrimental effect on product quality as it makes it very difficult to ensure that each single serving of hot cereal obtained from the bulk package contains the components and nutritional value claimed on the nutrition fact panel (NFP). Accordingly, the nutritional value and flavor intensity of each single serving of hot cereal obtained from a bulk package varies significantly, which has negatively impacted consumer acceptance of flavored bulk cereal products such as flavored bulk canned oats.

Most flavored oatmeal offerings therefore are provided to consumers in single serving pouches, wherein each pouch contains the necessary ingredients to meet the NFP claims for single serving on the food label. In this pouched form, settling of flavoring agents, sweeteners, and/or inclusions is of little concern as the product is prepared by pouring the entire contents of the pouch into a cooking vessel, adding water to the cooking vessel, and then cooking the mixture on a stove top or in a microwave oven using prescribed methods.

In contrast, bulk oat cereal products are generally prepared by pouring or scooping a portion of a multi-serving bulk package into the cooking vessel in which differential settling of the ingredients in the bulk package affects the nutritional value and flavor intensity of each portion. Accordingly, the first single serving portion of heat cereal removed from the bulk package can have significantly different flavor intensity and nutritional value compared to the last single serving portion removed from the bottom of the bulk package. As the flavoring agents and inclusions generally settle to the bottom of the bulk package over time, single serving portions removed from the bottom of the bulk package can have a concentration of flavoring agents and inclusions that can negatively impact the taste and texture of the finished product. Therefore, a need exists for bulk hot cereal compositions in which each single serving obtained from the bulk cereal composition contains substantially the same flavor intensity and nutritional value.

### SUMMARY

Agglomerated flavor clusters comprising a binder syrup, grain, sweetener, and flavoring agent, and hot cereal compositions comprising the agglomerated clusters are disclosed. The binding syrup generally comprises about 3% to about 30% gum by weight and about 50% to about 95% of a sugar component comprising one or more sugar alcohols. The agglomerated clusters are hydroscopic and can be directly consumed similar to granola or mixed into a bulk hot cereal composition to provide a flavored bulk hot cereal. When heated, the agglomerated clusters liquefy and coat the grain components of the hot cereal composition providing a flavored hot cereal composition. As the agglomerated clusters exhibit reduced settling in the hot cereal composition, each single serving of the bulk hot cereal composition comprises substantially the same flavor intensity and nutritional value.

Methods of making the agglomerated flavor clusters of the disclosure are also disclosure. The methods generally include forming a binder syrup; mixing the binder syrup with grain, sweetener, flavoring agent, and one or more optional ingredients such as salt, preservatives, inclusions, and colorants, to form an aggregated mass; and cooling the aggregated mass to form agglomerated clusters. The cooling can include tumbling or low shear mixing to regulate the size of the finished clusters.

### BRIEF DESCRIPTION OF FIGURES

FIG. 1 shows a process of making agglomerated flavor clusters of the disclosure.

FIG. 2 shows an alternative process of making agglomerated flavor clusters of the disclosure.

FIG. 3 shows a hot oat cereal composition comprising agglomerated flavor clusters of the disclosure.

### DETAILED DESCRIPTION

Agglomerated flavor clusters comprising a binder syrup, grain, sweetener, and flavoring agent, and hot cereal compositions comprising the agglomerated clusters are disclosed. The agglomerated clusters are hydroscopic and can be directly consumed similar to granola or mixed into a bulk hot cereal composition to provide a flavored bulk hot cereal. The term “bulk” as used herein means the hot cereal composition is provided in a container or package that contains more than one serving of the product as defined by the nutrition fact panel (NFP) on the container or package. A single serving of hot cereal composition typically contains between about 30 grams to about 80 grams. Bulk containers or packages commonly used for hot cereal compositions generally include from about 2 to about 20 single servings. When heated, the agglomerated clusters liquefy and coat the grain components of the hot cereal composition providing a flavored hot cereal composition. As the agglomerated clusters exhibit reduced settling in the hot cereal composition, each single serving of the bulk hot cereal composition comprises substantially the same flavor intensity and nutritional value.

The agglomerated clusters typically include from about 5% to about 25% binder syrup by weight. In an embodiment, the agglomerated clusters comprise from about 5% to about 20% binder syrup by weight. In an embodiment, the agglomerated clusters comprise from about 5% to about 15% binder syrup by weight. In another embodiment, the agglomerated clusters comprise about 5% to about 10% binder syrup by weight.

The binder syrup comprises a sugar component and one or more gums. The sugar component includes one or more sugar alcohols. The sugar component can also include a mixture comprising corn syrup, such as high maltose corn syrup or high fructose corn syrup, and one or more sugar alcohols. Examples of sugar alcohols include, but are not limited to, glycerin erthyritol, threitol, arabitol, xylitol, ribitol, mannitol, sorbitol, galactitol, fucitol, iditol, inositol, volemitol, isomalt, maltitol, lactitol, polyglycitol, and hydrogenated starch hydrosylates (HSH). The binder syrup typically comprises about 50% to about 95% sugar component by weight, the balance of the binder syrup comprising the gum component. In an embodiment, the binder syrup comprises about 60% to about 90% sugar component by weight. In another embodiment, the binder syrup comprises about 70% to about 90% sugar component by weight. In another embodiment, the binder syrup comprises about 75% to about 85% sugar component by weight. In yet another embodiment, the binder syrup comprises about 78% to about 82% sugar component by weight. In embodiments in which the sugar component does not contain corn syrup, at least one sugar alcohol comprising the sugar component is in syrup form to provide a base for the binder syrup.

The sweetness of the binder syrup can be controlled by regulating the amount of sugar alcohol and/or corn syrup in the sugar component, and/or by combining two or more sugar alcohols in the sugar component to provide the desired sweetness. In an embodiment, the sugar component comprises corn syrup and one or more sugar alcohols, the weight ratio of corn syrup to sugar alcohol being about 1:1 to about 3:1. In another embodiment, the sugar component comprises a first sugar alcohol selected from xylitol, maltitol, HSH, and erythritol and a second sugar alcohol selected from arabitol, glycerin, HSH, isomalt, lactitol, mannitol, and sorbitol. In a preferred embodiment, the sugar component comprises a mixture of glycerin and maltitol. In embodiments, the sugar component comprises a weight ratio of the first sugar alcohol to the second sugar alcohol from about 1:1 to about 3:1.

Examples of gums include, but are not limited to, gum arabic, guar gum, xanthan gum, locust bean gum, gum tragacanth, alternan, tragacanth, carrageenan, cellulose gum and mixtures thereof including gum arabic replacers as well as guar gum replacers. In an embodiment, the gum replacer comprises one or more gums, starch, and maltodextrin. In an embodiment, a guar gum replacer comprises cellulose, maltodextrin, and corn starch. Preferably the gum is thermally reversible and does not swell when hydrated and/or heated. In an embodiment, the gum comprises gum arabic. The binder syrup typically comprises about 3% to about 30% gum by weight, the balance of the binder syrup comprising the polyol component. In an embodiment, the binder syrup comprises about 10% to about 30% gum by weight. In another embodiment, the binder syrup comprises about 15% to about 25% gum by weight. In yet another embodiment, the binder syrup comprises about 18% to about 22% gum by weight.

The agglomerated clusters of the disclosure typically include from about 10% to about 60% grain by weight. In an embodiment, the clusters comprise from about 25% to about 50% grain by weight. In another embodiment, the clusters comprise from about 30% to about 45% grain by weight. In yet another embodiment, the clusters comprise from about 20% to about 35% grain by weight. Preferably, the grain is a cereal grain. Examples of cereal grains include corn, rice, wheat, rye, barley, oats, buckwheat, and the like. The grain can be whole grain, hulled grain, flaked grain, rolled grain, cut grain, farina, grit, polenta, and mixtures thereof. Preferred grains include oat groats, rolled oats, and steel cut oats. In an embodiment, the grain comprises oat groats, rolled oats, steel cut oats, and mixtures thereof. In another embodiment, the grain comprises rolled oats.

The agglomerated clusters of the disclosure typically include from about 0.5% to about 55% sweetener by weight. The sweetener can be natural or artificial sweetener including brown sugar, honey, sugars including sucrose, dextrose, fructose, and maltose, barley malt, high fructose corn syrup, corn syrup solids, sucralose, aspartame, saccharin, cyclamates, stevia, Acesulfame K, and the like. A preferred sweetener is sugar. In embodiments, the sugar is a fine or extra fine sugar. The amount of sugar in the agglomerated clusters can be reduced by combining the sugar with one or more non-nutritive sweeteners, such as sucralose, aspartame, saccharin, cyclamates, or stevia, to obtain clusters having the desired level of sweetness. In embodiments, the sweetener is a non-nutritive sweetener and comprises from about 0.5% to about 3% by weight of the agglomerated clusters.

The agglomerated clusters of the disclosure typically include from about 0% to about 8% flavoring agent by weight. The flavoring agent can be a natural flavoring agent, artificial flavoring agent, or a mixture thereof. Examples of natural flavoring agents include vanilla, spices such as cinnamon, allspice, cloves, ginger, cassia, cocoa, chocolate, maple syrup solids, brown sugar, tea powders and dried fruit powders. Examples of artificial flavoring agents include maple flavor, butterscotch, vanilla, fruit flavors such as raspberry, strawberry, orange, apple and others. In an embodiment, the agglomerated clusters include from about 0.05% to about 6% by weight of flavoring agent. In another embodiment, the agglomerated clusters include from about 0.05% to about 3% by weight of flavoring agent. In yet another embodiment, the agglomerated clusters include from about 0.1% to about 2% by weight of flavoring agent.

The agglomerated clusters of the disclosure can optionally include salt, dusting agent preservatives, inclusions, and/or colorants. Preferred salts include fine salt, extra fine salt, and flour salt. In an embodiment, the agglomerated clusters comprise from about 0.05% to about 3% salt by weight. Suitable preservatives include tocopherols, ascorbic acid, butylated hydroxyanisole (BHA), butylated hydroxytoluene (BHT), and the like. In an embodiment, the agglomerated clusters comprise from about 0 ppm to about 50 ppm preservatives by weight.

Examples of colorants include caramel coloring, FD&C colorings such as blue no.1, blue no. 2, green no. 3, red no. 3, red no. 40, yellow no. 5, and yellow no. 6, and natural colors such as beta-carotenes, anthocyanins, annatto, chlorophyllin, cochineal, betanin, curcuminoids, and carotenoids. In an embodiment, the agglomerated clusters include from about 0% to about 5% colorants by weight.

A dusting agent can be added to the agglomerated clusters to reduce the stickiness of the clusters and/or to fortify the clusters with vitamins and/or minerals. The dusting agent can be any dry material suitable for consumption which coats the aggregated clusters and reduces their stickiness. Examples of dusting agents include vitamin powders including vitamin A, vitamin B₅, vitamin B₆, vitamin B₁₂, vitamin C, biotin, folate, niacin, riboflavin, thiamine, and tocopherols, mineral powders including calcium and/or iron, calcium carbonate, ferric orthophosphate, and microcrystalline cellulose. In an embodiment, the agglomerated clusters include from about 0% to about 4% dusting agent by weight.

Inclusions can be added to the agglomerated clusters to provide additional flavoring and/or texture. Examples of inclusions include dehydrated fruit, chocolate chips, coconut, nuts, additional grain pieces, confections, and infused fruit. Examples of dehydrated fruit include apples, raisins, peaches, blueberries, cranberries, pineapple, strawberries, figs, prunes, dates, and the like. Examples of nuts include walnuts, pecans, almonds, peanuts, cashews, and the like. In an embodiment, the agglomerated clusters comprise from about 0% to about 30% inclusions by weight.

Several embodiments of agglomerated clusters of the disclosure are shown in Table 1.

TABLE 1

| Ingredient | Formulation A (wt %) | Formulation B (wt %) |
|---|---|---|
| Binder syrup | 16%-23% | 13%-18% |
| Oats | 18%-32% | 35%-51% |
| Sweetener | 30%-45% | 25%-40% |
| Flavoring Agent | 1%-3% | 2%-4% |
| Salt | 0%-2% | 0%-2% |
| Dusting Agent | 0%-3% | 0%-3% |

The binder syrup of the disclosure is typically prepared by adding the gum component to the sugar component in a cooking vessel or a mixer equipped with a heating mantle, and heating the mixture while stiffing to about 160° F. to about 200° F., preferably between about 180° F. to about 190° F. Once prepared, the binder syrup can be used immediately to prepare agglomerated flavor clusters of the disclosure or dispensed into one or more containers for later use and allowed to cool.

Agglomerated flavor clusters of the disclosure are typically prepared by mixing heated binder syrup with the grain component, stirring the sweetener, flavoring agent, and optional ingredients such as salt, preservatives, inclusions, and colorants into the mixture, and optionally cooling the mixture to form the agglomerated clusters. A portion of the sweetener can be added to the grain before the grain is mixed with the binder syrup to control the finished size of the clusters. In an embodiment, the ratio of sweetener added before and after the binder syrup is from about 1:3 to about 3:1.

Cooling of the agglomerated clusters generally comprises low shear mixing or tumbling. Generally, no drying of the agglomerated clusters is required during the cooling process as the mixture does not necessarily contain water. Because cooling of the clusters does not require drying, the cost of producing the agglomerated clusters is decreased, volatile flavors in the agglomerated clusters are not lost to heating, toasted flavor notes are not introduced into the agglomerated clusters, and the agglomerated clusters do not develop a toasted appearance which allows them to better visually blend into the uncooked grain component of a hot cereal composition.

The finished particle size of the agglomerated clusters can be selected by the intensity and duration of the mixing or tumbling during the cooling process. The greater the intensity and/or duration of mixing or tumbling, the smaller the particle size of the finished clusters. As the agglomerated particles can be consumed directly, similar to a granola product, or mixed into a hot cereal composition, the particle size of the agglomerated particles can vary greatly and is generally selected based upon the requirements of the end product. The agglomerated clusters can have a particle size of about 0.3 cm to about 2 cm. When mixed into a bulk hot cereal composition, such as bulk canned oats, the agglomerated clusters typically have a particle size within at least about 70% of the average particle size of the grain component of the hot cereal composition. In an embodiment, the agglomerated clusters have a particle size of about 0.7 cm to about 1.2 cm. When provided as a snack-type product, similar to a granola product, the clusters can be provided as bit-size nuggets having a particle size of about 1.0 cm to about 4.0 cm. In an embodiment, the agglomerated clusters have a particle size of about 1.5 cm to about 2.0 cm.

In embodiments, the mixture of binder syrup, grain, sweetener, flavoring agent, and optional ingredients forms an aggregated mass. Once cooled, the aggregated mass is transferred to an enrobing pan and allowed to tumble while adding the dusting agent. The size of the finished agglomerated clusters can be selected by the intensity and duration of tumbling and amount of dusting agent. In an optional step, additional grain is added to the enrobing pan during tumbling to further aid in preventing clumping of the agglomerated clusters and to provide visual stimulation to the consumer.

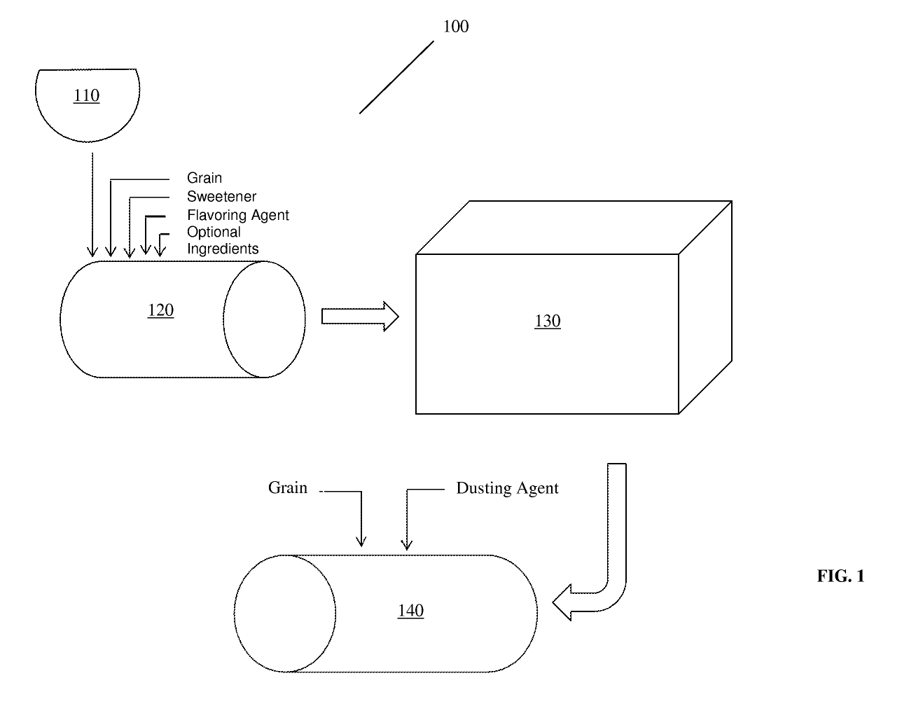

FIG. 1 shows an embodiment of a larger scale process 100 of making agglomerated clusters of the disclosure. The process shown in FIG. 1 utilizes a single screw or twin screw mixer 120, such as a Rico mixer, having multiple sections. The mixer 120 can include a high shear mixing section, a low shear mixing section, and optionally a low shear cooling section. The ingredients for the binder syrup are mixed in a kettle 110 under high shear and heated. In an embodiment, the ingredients are heated to about 160° F. to about 200° F., preferably between about 180° F. to about 190° F., to form the binder syrup. The binder syrup is then transferred to the mixer 120 where the grain, sweetener, flavoring agent, and optional ingredients such as salt, preservatives, inclusions, and colorants are added to the binding syrup to form an aggregated mass. Generally the aggregated max is formed under low shear mixing conditions. If the mixer 120 in configured with an optional cooling section or the process is configured to include an optional chiller 130, the aggregated mass is transferred to the low shear cooling section of mixer 120 or chiller 130 and the mass is broken into agglomerated clusters as the mass is cooled. The finished particle size can be selected based upon the intensity and duration of shear or tumbling in the cooling section. Dusting agent and additional grain can be added to the clusters in the low shear cooling section to reduce the stickiness and clumping of the clusters and to provide visual stimulation for the consumer. The dusting agent and additional grain can also be added to the clusters in an optional enrober 140, such as an enrobing drum, in which the clusters are transferred directly from the mixer 120 or chiller 130 to the enrober 140.

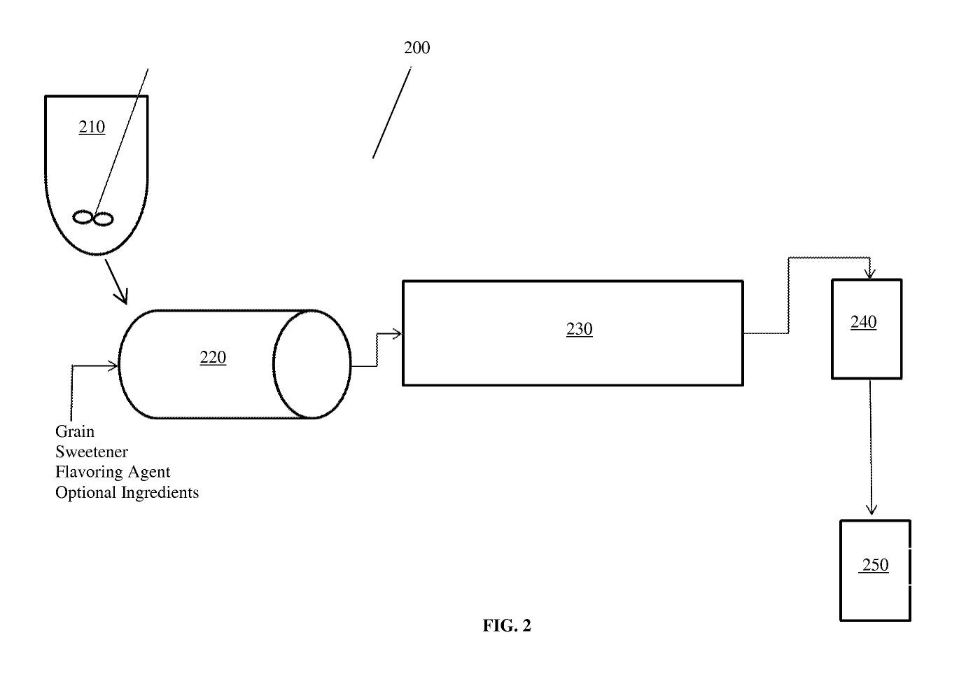

FIG. 2 shows an alternate embodiment of a process 200 of making agglomerated clusters of the disclosure. The process shown in FIG. 2 utilizes a conventional granola production line. The binder syrup is mixed in a kettle 210 and heated as described for the process shown in FIG. 1. The heated binder syrup is then transferred to an enrober 220, such as an enrobing drum, where the grain, sweetener, flavoring agent, and optional ingredients such as salt, preservatives, inclusions, and colorants are added to the binding syrup to form clusters, the clusters typically comprising a temperature of about 90 to about 100° F. A dusting agent can optionally be added to the enrober following cluster formation or applied to the clusters as the clusters exit the enrober. The clusters are then transferred to an oven 230. In the oven, air is blown over the clusters, generally without heating, as the clusters pass through the oven to cool the clusters. The oven 230 can optionally be configured to include a cooling section. Once cooled, the clusters are transferred to a sizing operation 240, where dusting agent and/or additional grain can be added to the mixture to reduce stickiness and clumping of the clusters and to provide visual stimulation for the consumer, and then to a packaging operation 250.

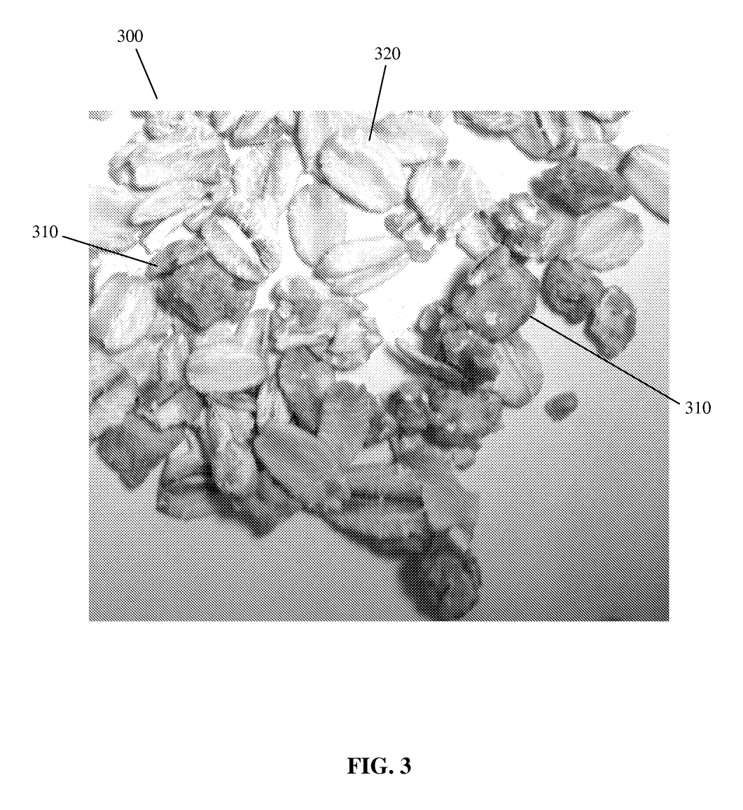

Hot cereal compositions containing agglomerated flavor clusters of the disclosure are also provided. The agglomerated clusters are dispersed within or mixed, preferably homogenously, into the grain component of the hot cereal compositions. One example of a hot cereal composition of the disclosure is shown in FIG. 3. As shown in FIG. 3, the hot cereal composition 300 contains agglomerated flavor clusters 310 dispersed within uncooked rolled oats 320. The hot cereal compositions of the disclosure can be provided as a bulk composition or in single serving containers, such as a pouch, cup, or bowl. The hot cereal compositions include an uncooked or partially cooked grain component comprising one or more whole grains, cracked grains, or cut grains, wheat bran, oat bran, rolled oats, oat groats, steel cut oats, corn grits, barley grits, buckwheat grits, and mixtures thereof. Examples of whole grains, cracked grains, and/or cut grains typically included in hot cereal compositions include corn, wheat, barley, rye, oats, brown rice, soy beans, millet, sorghum, sunflower seeds, flaxseeds, and mixtures thereof. In an embodiment, the grain component comprises oat groats, rolled oats, steel cut oats, and mixtures thereof. In another embodiment, the grain component comprises rolled oats.

The hot cereal compositions of the disclosure generally contain a weight ratio of about 1:4 to about 3:1 agglomerated clusters to grain component of the cereal composition. In an embodiment, the hot cereal composition comprises a ratio of clusters to grain component of about 1:1 to about 2:1. In another embodiment, the hot cereal composition comprises a ratio of clusters to grain component of about 1:4 to about 1:2. In an embodiment, the hot cereal composition of the disclosure comprises about 30% to about 70% grain by weight and about 30% to about 70% agglomerated clusters by weight. In another embodiment, the hot cereal composition of the disclosure comprises about 30% to about 40% grain by weight and about 60% to about 70% agglomerated clusters by weight. In yet another embodiment, the hot cereal composition of the disclosure comprises about 40% to about 50% grain by weight and about 50% to about 60% agglomerated clusters by weight.

When mixed into a bulk hot cereal composition, such as bulk canned oats, the agglomerated clusters generally comprise a bulk density within at least 70% the bulk density of the grain component of the hot cereal composition to prevent or reduce differential settling of the agglomerated clusters and grain component. In an embodiment, the agglomerated clusters have a bulk density of about 0.3 g/cc to about 0.8 g/cc. In another embodiment, the agglomerated clusters have a bulk density of about 0.3 g/cc to about 0.5 g/cc. In yet another embodiment, the agglomerated clusters have a bulk density of about 0.3 g/cc to about 0.4 g/cc. When heated, the agglomerated clusters liquefy and coat the grain components of the hot cereal composition providing a flavored hot cereal composition. As the agglomerated clusters exhibit reduced settling in the hot cereal composition, each single serving of the bulk hot cereal composition comprises substantially the same flavor intensity and nutritional value.

When mixed into a hot cereal composition, the agglomerated clusters typically have a particle size within at least about 70% of the average particle size of the grain component of the hot cereal composition, but can be adjusted as desired dependent on the size of the grain into which the agglomerated clusters will be mixed and the desired bulk density of the clusters. As the agglomerated clusters typically contain grain similar to the grain component of the hot cereal composition, clusters having a particle size within at least about 70% of the average particle size of the grain component of the hot cereal composition blend into the hot cereal composition providing a bulk flavored hot cereal composition having a pleasing visual appearance to the consumer substantially devoid of dark specs and grind outs. In an embodiment, the agglomerated clusters comprise a particle size of about 0.7 cm to about 1.2 cm. In another embodiment, the agglomerated clusters comprise a particle size of about 0.6 cm to about 1.0 cm.

The hot cereal compositions of the disclosure are typically cooked by boiling the composition in an amount of water, milk, or mixture thereof using a stove top or microwave. For microwave cooking using about a 1000 W to 1250 W microwave, a single serving of the hot grain cereal composition of the disclosure is typically mixed with about ½ cup to about 1 cup of water, milk, or a mixture thereof in a single serving (2 cup) cooking vessel, such as a microwaveable bowl, and then cooked in the microwave on the HIGH setting for 1-5 min, preferably 1-3 min. For stove stop cooking, a single serving of hot grain cereal composition of the disclosure is typically prepared by bringing about ½ cup to about 1 cup of water, milk, or mixture thereof to boil in a cooking vessel having a volume of 2 cups of greater, stirring the composition into the boiling water and/or milk, and then cooking the mixture over medium heat for about 1 minute to about 5 minutes or until thickened.

### EXAMPLE

The following example is illustrative, and other embodiments exist and are within the scope of the present invention.

### Example 1

A method of making agglomerated flavor clusters was developed. A binder syrup was prepared by adding 396 grams (g) of gum arabic to 594 g of glycerin and 990 g malitol in a saucepan. The mixture was heated to185° F. with stirring and then dispensed into closed storage cups for later use. An aggregate preblend was prepared by adding 277 g rolled oats, 6.4 g salt, 16.8 g maple brown sugar, and approximately 48 g sugar to a 5 quart mixer configured with a paddle. The mixture was mixed at slow speed. One hundred g of heated (180° F.) binder syrup was added to the mixture and the mixture was mixed until well mixed. Continuing the mixing, approximately 97 g of sugar was added to the mixture to form aggregates. The ratio of sugar added before and after the binder syrup was varied between 1:3 to 3:1 to control the size of the aggregates. The blended aggregate mass having a temperature of about 80 to about 100° F. was then spread onto parchment lined papers at a thickness between 0.5 to 1 inch and allowed to cool. Once cooled, the cooled aggregate mass was transferred to an enrobing pan and allowed to tumble while adding from about 2 to about 6 g of dusting agent to coat the aggregate pieces and reduce their stickiness. Calcium carbonate, microcrystalline cellulose, or a mixture of vitamin premix, ferric orthophosphate, and calcium carbonate was used as the dusting agent. After the dusting step, 325 g of rolled oats was added to the enrobing pan to further aid in preventing clumping of the aggregate pieces and to provide visual stimulation to the consumer.

While certain embodiments of the invention have been described, other embodiments may exist. While the specification includes a detailed description, the invention's scope is indicated by the following claims. Furthermore, while the specification has been described in language specific to structural features and/or methodological acts, the claims are not limited to the features or acts described above. Rather, the specific features and acts described above are disclosed as illustrative aspects and embodiments of the invention. Various other aspects, embodiments, modifications, and equivalents thereof which, after reading the description herein, may suggest themselves to one of ordinary skill in the art without departing from the spirit of the present invention or the scope of the claimed subject matter.

What is claimed is:

1. An agglomerated flavor cluster, comprising:
about 10% to about 60% grain component by weight;
about 0.5% to about 55% sweetener by weight;
about 0% to about 8% flavoring agent by weight; and about
about 5% to about 25% binder syrup by weight, wherein the binder syrup comprises a sugar component and a gum.

2. The agglomerated flavor cluster of claim 1, wherein the grain comprises one or more of oat groats, rolled oats, and steel cut oats.

3. The agglomerated flavor cluster of claim 1, wherein the sweetener comprises sugar or sugar in combination with one of more non-nutritive sweeteners.

4. The agglomerated flavor cluster of claim 1, wherein the flavoring agent comprises a natural flavoring agent, artificial flavoring agent, or mixture thereof.

5. The agglomerated flavor cluster of claim 1, wherein the binder syrup comprises:
about 3% to about 30% gum by weight; and
about 50% to about 95% of a sugar component comprising one or more sugar alcohols.

6. The agglomerated flavor cluster of claim 5, wherein the sugar component comprises a first sugar alcohol and a second sugar alcohol in a weight ratio of about 1:1 to about 3:1.

7. The agglomerated flavor cluster of claim 6, wherein the first sugar alcohol comprises xylitol, maltitol, HSH, or erythritol and the second sugar alcohol comprises arabitol, glycerin, HSH, isomalt, lactitol, mannitol, or sorbitol.

8. The agglomerated flavor cluster of claim 6, wherein the first sugar alcohol comprises maltitol and the second sugar alcohol comprises glycerin.

9. The agglomerated flavor cluster of claim 5, wherein the sugar component comprises corn syrup and glycerin in a weight ratio of about 1:1 to about 3:1.

10. The agglomerated flavor cluster of claim 1, wherein the gum comprises gum arabic, guar gum, xanthan gum, locust bean gum, gum tragacanth, alternan, tragacanth, carrageenan, or mixtures thereof.

11. The agglomerated flavor cluster of claim 1, wherein the gum is thermal reversible.

12. The agglomerated flavor cluster of claim 1, wherein the gum comprises gum arabic.

13. The agglomerated flavor cluster of claim 1, wherein the agglomerated cluster is hydroscopic.

14. The agglomerated flavor cluster of claim 1, wherein the agglomerated cluster comprises a particle size of about 0.3 cm to about 2 cm.

15. A hot cereal composition comprising a plurality of agglomerated flavor clusters according to claim 1.

16. The hot cereal composition of claim 15, comprising:
about 30% to about 70% grain component by weight; and
about 30% to about 70% agglomerated flavor clusters by weight,
wherein the agglomerated flavor clusters are dispersed within the grain component.

17. The hot cereal composition of claim 16, wherein the grain component comprises one or more of oat groats, rolled oats, and steel cut oats.

18. The hot cereal composition of claim 16, wherein the agglomerated clusters comprise a particle size within at least about 70% of the average particle size of the grain component.

19. The hot cereal composition of claim 16, wherein the agglomerated clusters comprise a bulk density within at least 70% the bulk density of the grain component.

20. The hot cereal composition of claim 16, wherein upon heating of the hot cereal composition the agglomerated clusters liquefy and coat the grain component.

21. A method of making a flavored hot cereal composition, comprising mixing a quantity of agglomerated flavor clusters according to claim 1 with a quantity of grain component wherein the weight ratio of agglomerated flavor clusters to grain component is about 1:4 to about 3:1 and the agglomerated flavor clusters are dispersed within the grain component.

22. The method of claim 21, wherein the grain component comprises one or more of oat groats, rolled oats, and steel cut oats.

23. A method of making agglomerated flavor clusters of claim 1, comprising:
a) forming a binder syrup, the binding syrup comprising about 3% to about 30% gum by weight and about 50% to about 95% of a sugar component comprising one or more sugar alcohols;
b) mixing the binder syrup with grain, sweetener, and flavoring agent to form an aggregated mass; and
c) cooling the aggregated mass to form agglomerated clusters, wherein the cooling comprises tumbling or low shear mixing.

24. The method of claim 23, wherein the binder syrup is formed in a cooking vessel or mixer comprising a heated mantle.

25. The method of claim 23, wherein the binder syrup in b) comprises a temperature of about 160° F. to about 200° F.
